(19) United States
(12) Patent Application Publication
(10) Pub. No.: US 2024/0270334 A1
(43) Pub. Date: Aug. 15, 2024

(54) Electro-Hydraulic Combination Driven Explosion-Proof Legged Robot

(71) Applicant: Sevnce Robotics Co., Ltd., Chongqing City (CN)

(72) Inventors: Dong Zhu, Chongqing City (CN); Xiaodong Hu, Chongqing City (CN); Guomei Tang, Chongqing City (CN); Li Wang, Chongqing City (CN); Dawen Chen, Chongqing City (CN); Zhen Wang, Chongqing City (CN); Chao Chen, Chongqing City (CN)

(21) Appl. No.: 18/536,556

(22) Filed: Dec. 12, 2023

(30) Foreign Application Priority Data
Feb. 14, 2023 (CN) 202310110960.2

(51) Int. Cl. B62D 57/032

(52) U.S. Cl. CPC B62D 57/032

(57) ABSTRACT

An electro-hydraulic combination driven explosion-proof legged robot which includes a positive-pressure chamber body and a leg-foot assembly. The leg-foot assembly includes a hydraulic cylinder. A servo pump is arranged inside the chamber body. The hydraulic cylinder is located outside the chamber body. The chamber body has a chamber wall formed with oil inlet and outlet holes configured to intercommunicate the servo pump with the hydraulic cylinder. The leg-foot assembly includes a mounting bracket, a leg-foot forward-and-backward swing mechanism, a hip joint mechanism and a leg-foot mechanism. The leg-foot forward-and-backward swing mechanism and the hip joint mechanism are connected outside the chamber body through the mounting bracket. The hip joint mechanism is connected to the leg-foot mechanism and is able to drive the leg-foot mechanism to swing laterally inward and outward. The leg-foot forward-and-backward swing mechanism is connected to the hip joint mechanism in a coaxial transmission manner.

### CROSS REFERENCE TO RELATED APPLICATION

The present application claims the benefit of Chinese application No. 202310110960.2 filed with the CNIPA on 14 Feb. 2023, the entire disclosure of which is incorporated herein by reference.

### TECHNICAL FIELD

The present disclosure relates to the technical field of robots, more particularly to an electro-hydraulic combination driven explosion-proof legged robot.

### BACKGROUND

With the development of intelligent equipment, robots are becoming increasingly widely used in people's work and life. Robots are divided into wheeled and legged types. The legged robots have better adaptability to ground contours and therefore become widely applied in scenarios such as routine inspection.

Relevant technologies can refer to the patent with application number of 202222609655.1, which disclosed a hydraulic pump controlled explosion-proof four-legged robot, including a hydraulic structure and a mechanical structure. The mechanical structure includes an explosion-proof chamber and a leg-foot assembly. The leg-foot assembly includes a lateral swing unit, a hip unit and a knee unit. The hydraulic structure includes an energy accumulator and a driving unit. The driving unit includes a servo motor, a hydraulic pump and a hydraulic cylinder that are connected sequentially. Each lateral swing unit, hip unit or knee unit is controlled by one driving unit.

In view of the above relevant technologies, when the four-legged robot is employed to perform routine inspection in flammable and explosive environments, each joint motor of the four-legged robot is likely to cause an explosion while running. The robot is of no explosion-proof performance.

### SUMMARY

In order to solve the problem that current robots with electric control are of no explosion-proof performance while working in flammable and explosive environments, the present disclosure provides an electro-hydraulic combination driven explosion-proof legged robot.

An electro-hydraulic combination driven explosion-proof legged robot provided by the present disclosure employs the following technical solution.

An electro-hydraulic combination driven explosion-proof legged robot includes a positive-pressure chamber body and a leg-foot assembly. The leg-foot assembly includes a hydraulic cylinder. A servo pump is arranged inside the chamber body. The hydraulic cylinder is located outside the chamber body. The chamber body has a chamber wall formed with oil inlet and outlet holes configured to intercommunicate the servo pump with the hydraulic cylinder.

The leg-foot assembly includes a mounting bracket, a leg-foot forward-and-backward swing mechanism, a hip joint mechanism and a leg-foot mechanism. The leg-foot forward-and-backward swing mechanism and the hip joint mechanism are connected outside the chamber body through the mounting bracket. The hip joint mechanism is connected to the leg-foot mechanism and is able to drive the leg-foot mechanism to swing laterally inward and outward. The leg-foot forward-and-backward swing mechanism is connected to the hip joint mechanism in a transmission manner and is able to drive the hip joint mechanism to rotate.

According to the above technical solution, the chamber body employs a positive-pressure design, eliminating the likelihood of external flammable and explosive gases entering the chamber body to come into contact with electrical components, whereby achieving an explosion-proof effect. Since the hydraulic cylinder is located outside the chamber body, and a control unit and the servo pump are located inside the chamber body, the electro-hydraulic driving system achieves an electro-hydraulic separation effect, eliminating the likelihood of flammable and explosive gases coming into contact with electricity to cause an explosion, whereby an explosion-proof performance is achieved for the robot.

The leg-foot forward-and-backward swing mechanism is connected to the hip joint mechanism in a coaxial transmission manner, being conducive to optimizing a robot control algorithm program.

The control algorithm simplification principle is illustrated as below. Take the transmission between two adjacent joints as an example. A three-dimensional rectangular coordinate system 1 (x1, y1, z1) is rotated θ1 around the axis z1, and a three-dimensional rectangular coordinate system 2 (x2, y2, z2) is rotated θ2 around the axis x2. Generally, when conversion is performed between two joints, taking the coordinate system 1 as a reference coordinate system, the spatial coordinate of the coordinate system 2 relative to the coordinate system 1 is as follows.

$$[ \begin{matrix}{x}_{2} cos {θ}_{1} & - {x}_{2} sin {θ}_{1} & 0 & {x}_{2} \\ {y}_{2} sin {θ}_{1} & {y}_{2} cos {θ}_{1} & 0 & {y}_{2} \\ 0 & 0 & 1 & {z}_{2} \\ 0 & 0 & 0 & 1\end{matrix} ] ,$$

when axial lines of the two joints intersect at a point, that is, the origins of the two joint coordinate systems coincide, the x2, y2 and z2 in the matrix are 0 that represent the distance to the origins of the two joint coordinate systems, which can simplify the matrix expression in transmission control software. The simplified spatial coordinate is expressed as:

$$[ \begin{matrix}cos {θ}_{1} & - s in {θ}_{1} & 0 & 0 \\ sin {θ}_{1} & cos {θ}_{1} & 0 & 0 \\ 0 & 0 & 1 & 0 \\ 0 & 0 & 0 & 1\end{matrix} ] .$$

To sum up, the present disclosure includes the following beneficial technical effects. 1. An explosion-proof performance is achieved for the robot by means of the electro-hydraulic separation design and the positive-pressure chamber. 2. The difficulty of the control algorithm is reduced by means of the coaxial transmission design of joints of the leg-foot assembly of the robot.

### BRIEF DESCRIPTION OF THE DRAWINGS

FIG. 1 is a structure diagram of an electro-hydraulic combination driven explosion-proof legged robot according to an embodiment of the present disclosure.

FIG. 2 is a top view of FIG. 1.

FIG. 3 is a structure diagram of a leg-foot assembly of a robot according to an embodiment of the present disclosure.

FIG. 4 is a structure diagram of a mounting bracket.

FIG. 5 is a top view of FIG. 4.

FIG. 6 is a sectional view taken along line A-A of FIG. 5.

FIG. 7 is a structure diagram of a leg-foot forward-and-backward swing mechanism.

FIG. 8 is a top view of FIG. 7.

FIG. 9 is a sectional view taken along line B-B of FIG. 8.

FIG. 10 is a diagram of a connection structure at a slide rest.

FIG. 11 is a structure diagram of a driving gear assembly.

FIG. 12 is a structure diagram of a mounting seat.

FIG. 13 is a diagram of a connection structure of a hip joint mechanism and a thigh arm.

FIG. 14 is a structure diagram of a connecting piece.

FIG. 15 is a left view of FIG. 14.

FIG. 16 is a sectional view taken along line C-C of FIG. 15.

FIG. 17 is a structure diagram of a lateral swing driving assembly.

FIG. 18 is a sectional view of a hip joint mechanism.

FIG. 19 is a structure diagram of a leg-foot mechanism.

FIG. 20 is a sectional view taken along plane D-D of FIG. 19.

FIG. 21 is a structure diagram of a thigh arm.

FIG. 22 is a sectional view taken along plane E-E of FIG. 21.

FIG. 23 is a structure diagram of a shank arm.

FIG. 24 is a sectional view take along plane F-F of FIG. 23.

FIG. 25 is a partial structure diagram of a foot joint part.

FIG. 26 is a diagram of a connection structure of a chamber body and a mounting bracket.

FIG. 27 is a sectional view of a connection structure of a first cylinder, a mounting bracket and a first servo pump.

FIG. 28 is a sectional view of a connection structure of a second oil channel of a mounting bracket and a third servo pump.

FIG. 29 is a structure diagram of installation of fittings on an upper cover of a chamber body.

FIG. 30 is a top view of FIG. 29.

FIG. 31 is an EHA closed hydraulic system diagram of lateral swing and pitch of a hip joint mechanism according to the present disclosure.

FIG. 32 is an EHA closed hydraulic system diagram of a knee joint according to the present disclosure.

FIG. 33 is an FV diagram of directions of a load force and a hydraulic cylinder piston rod velocity.

FIG. 34 is a load condition of a knee joint.

FIG. 35 is a diagram of a load condition of a first hydraulic cylinder.

FIG. 36 is a diagram of a load condition of a second hydraulic cylinder.

Below is the description of reference numerals on the drawings.
1, a control assembly; 11, a chamber body; 111, a first oil outlet hole; 112, a first oil inlet hole; 113, a second oil outlet hole; 114, a second oil inlet hole; 12, a control unit; 13, a first servo pump; 14, a second servo pump; 15, a third servo pump; 16, a laser radar; 17, an RTK antenna; 18, an explosion-proof button; and 19, an explosion-proof audible and visual alarm.
2, a mounting bracket; 21, a first side plate; 22, a second side plate; 221, a fixing hole; 23, a connecting seat; 24, a fixing part; 25, a first shaft hole; 26, a second shaft hole; 27, a mounting groove; 28, a second oil channel; and 29, a first oil channel.
3, a leg-foot forward-and-backward swing mechanism; 31, a first hydraulic cylinder; 311, a piston rod; 32, a first slide rail; 33, a slide block; 34, a connecting block; 341, an insertion port; 342, a first ear plate; 343, a slope; 35, a first connecting rod; 36, a mounting seat; 361, a connecting part; 362, a second ear plate; 363, an opening; 364, a third shaft hole; 365, a fixing hole; 37, a toothed plate; and 38, a rotating shaft.
4, a connecting piece; 41, a mounting pipe; 411, a mounting hole; 412, a locating ring; 413, a mounting groove; 414, an operating hole; 415, a perforation; 416, a fixing hole; 42, a connecting ring; 43, a support arm; 431, a fourth shaft hole; 432, a pin hole; 433, a receding groove; 434, a wire channel; 44, a driven gear; 45, a bearing; and 46, an end cover.
5, a lateral swing driving mechanism; 51, a second hydraulic cylinder; 52, a second slide rail; 53, a slide rest; and 54, a second connecting rod.
6, a thigh arm; 61, a first lightening hole; 62, an outer ear plate; 63, an inner ear plate; 64, a mounting groove; 65, a pin hole; 66, a first knee ear plate; 67, a through hole; and 68, a wire hole.
7, a shank arm; 71, a second lightening hole; 72, a second knee ear plate; 73, a perforation; 74, a foot connecting end; 75, a mounting hole; and 76, an extension groove.
8, a foot joint; 81, a foot cover; 811, an anti-slip groove; 82, an inner capsule; 821, a threaded section; 83, a cover plate; 84, a fixing nut; and 85, a pressure sensor.
9, a knee joint; 91, a third hydraulic cylinder; 911, a cylinder; 912, a piston rod; 913, a mounting frame; 92, a first connection part; and 93, a second connection part.
10, a cable.
k1, a two-way pump; k2, a motor; k3, a first main oil circuit; k4, a second main oil circuit; k5, an energy accumulator; k6, a symmetric actuating unit; k7, a first one-way balance valve; k8, a second one-way balance valve; k9, an oil filling port; k10, a first valve port; k1l, a first overflow valve; k12, a second overflow valve; k13, a second valve port; k14, a control valve port; k15, a third valve port; k16, a one-way valve; k17, a pressure sensor; and k18, a temperature sensor.

### DETAILED DESCRIPTION OF THE EMBODIMENTS

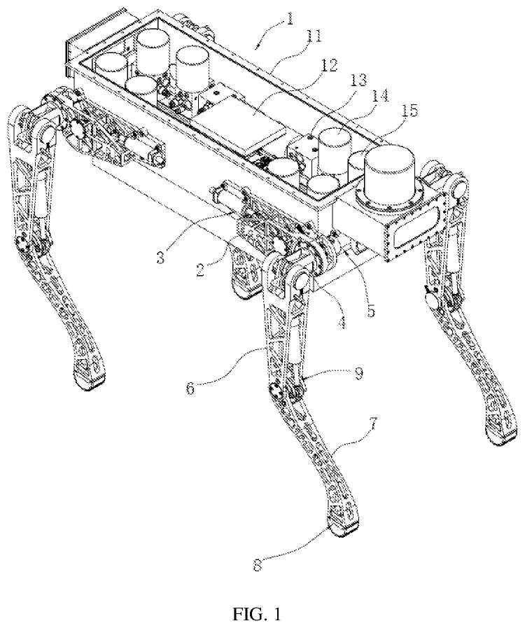

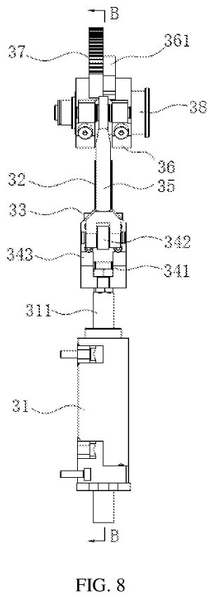

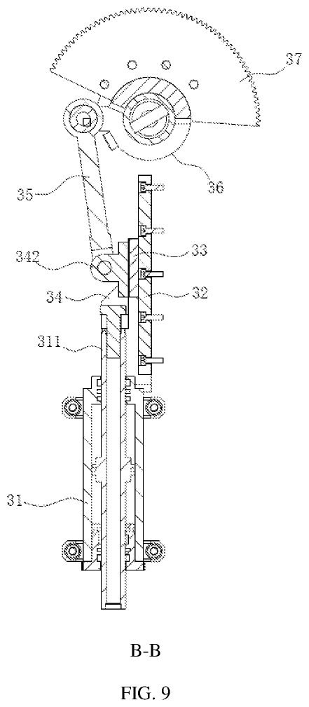

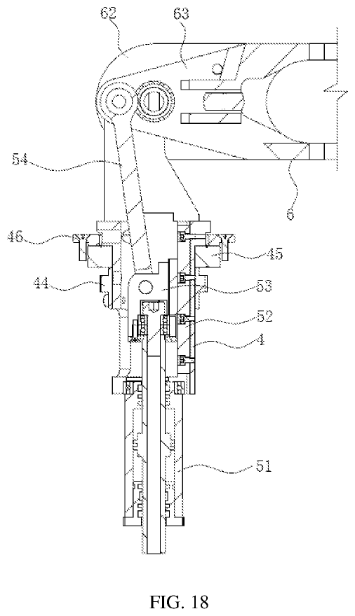

The present disclosure is described below in further detail with reference to FIG. 1 to FIG. 36.

The embodiments of the present disclosure provide an electro-hydraulic combination driven explosion-proof legged robot.

Referring to FIG. 1 to FIG. 3, an electro-hydraulic combination driven explosion-proof legged robot includes a control assembly 1 and a plurality of leg assemblies. Each leg assembly includes a mounting bracket 2, a leg-foot forward-and-backward swing mechanism 3, a hip joint mechanism and a leg-foot mechanism. The hip joint mechanism includes a connecting piece 4 and a lateral swing driving mechanism 5. The leg-foot mechanism includes a thigh arm 6 and a shank arm 7. The connecting piece 4 is rotatably connected to the mounting bracket 2. The lateral swing driving mechanism 5 is connected to the connecting piece 4. The lateral swing driving mechanism 5 is connected to the thigh arm 6 and drives the thigh arm 6 to perform inward and outward lateral swing. The leg-foot forward-and-backward swing mechanism 3 drives the hip joint mechanism to rotate, so that the leg-foot mechanism swings forward and backward. The leg-foot forward-and-backward swing mechanism 3 and the hip joint mechanism are mounted on the mounting bracket 2 to achieve coaxial transmission, whereby simplifying the difficulty of control system algorithms.

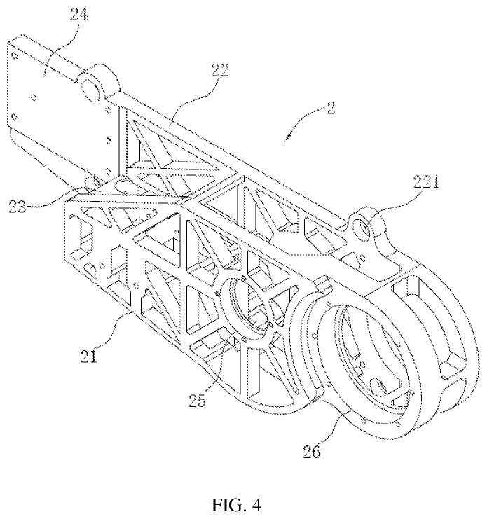

Referring to FIG. 4 to FIG. 6, the mounting bracket 2 includes a first side plate 21, a second side plate 22 and a connecting seat 23. The first side plate 21 and the second side plate 22 are arranged in parallel. The connecting seat 23 is fixed between the first side plate 21 and the second side plate 22.

The first side plate 21 and the second side plate 22 each have a middle part formed with a first shaft hole 25 correspondingly. The first side plate 21 and the second side plate 22 each have one end formed with a second shaft hole 26 correspondingly. A connecting line between centers of the first shaft hole 25 and the second shaft hole 26 is parallel to a length direction of the connecting seat 23.

In order to reduce the overall weight of the mounting bracket 2, both first side plate 21 and the second side plate 22 are formed with lightening holes, such that the first side plate 21 and the second side plate 22 are of a hollow-out structure. End parts of the first side plate 21 and the second side plate 22 corresponding to the second shaft hole 26 are contoured as a circular arc.

One end of the second side plate 22 far away the second shaft hole 26 has a prolonged section than the first side plate 21 to form a fixing part 24. One side of the second side plate 22 far away the connecting seat 23 is formed with a fixing hole 221. One end of the first side plate 21 far away the second shaft hole 26 is designed as a trapezoid shape. An area of the mounting bracket 2 located between the connecting seat 23 and the second shaft hole 26 is formed with a mounting groove 27. The mounting bracket 2 is formed with nail holes around the first shaft hole 25 and the second shaft hole 26. The mounting bracket 2 is further provided with a plurality of connecting ribs around the second shaft hole 26. The connecting seat 23 is formed thereon with nail holes.

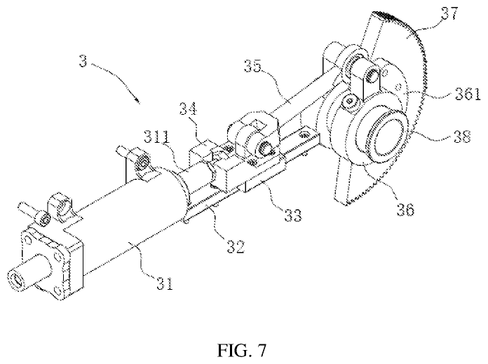

Referring to FIG. 7 to FIG. 9, the leg-foot forward-and-backward swing mechanism 3 includes a forward-and-backward swing driving assembly and a driving gear assembly. The forward-and-backward swing driving assembly drives the driving gear assembly to achieve transmission.

The forward-and-backward swing driving assembly includes a first hydraulic cylinder 31, a first slide rail 32, a slide rest and a first connecting rod 35. The first slide rail 32 can be fixed on the connecting seat 23 of the mounting bracket 2 through a bolt. A length direction of the first slide rail 32 is perpendicular to an axial line of the first shaft hole 25. The slide rest is able to slide relatively along the length direction of the first slide rail 32. A cylinder body of the first hydraulic cylinder 31 is fixed to the fixing part 24 of the mounting bracket 2 through a bolt. A piston rod 311 of the first hydraulic cylinder 31 is connected to the slide rest, so that the first hydraulic cylinder 31 is able to drive the slide rest to reciprocate along the first slide rail 32. The first hydraulic cylinder 31 can select a double acting hydraulic cylinder.

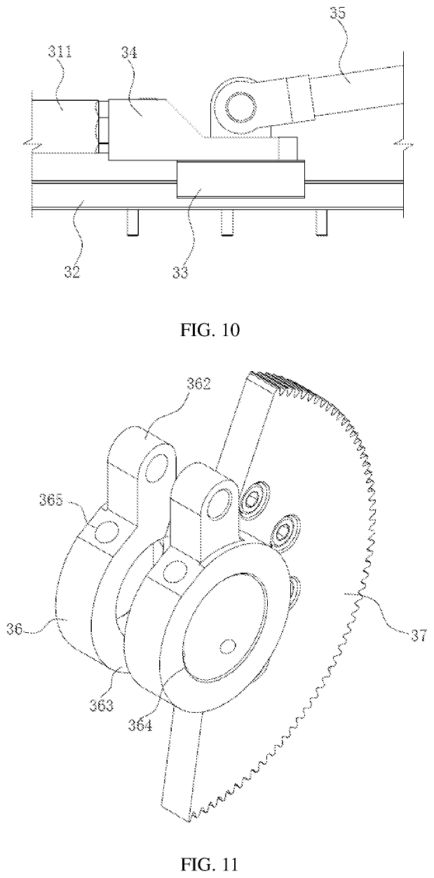

Referring to FIG. 10, the slide rest includes a slide block 33 and a connecting block 34 that are fixedly connected. The fixing manner between the slide block 33 and the connecting block 34 can be bolt connection, clamping, embedding, welding or integrated molding, etc. The slide block 33 is formed thereon with a chute mated with the first slide rail 32. The slide block 33 is able to slide relatively along the length direction of the first slide rail 32. The connecting block 34 herein selects to fix to the slide block 33 using a bolt, which is convenient to detach and replace.

One end of the connecting block 34 is formed with an insertion port 341. An end part of the piston rod 311 of the first hydraulic cylinder 31 is inserted into the insertion port 341 to fix. The other end of the connecting block 34 is fixed with a first ear plate 342. An end of the first connecting rod 35 is hinged with the first ear plate 342 through a pin rod. An axial line of the pin rod is perpendicular to the first slide rail 32 and parallel to a plane of the connecting block 34 far away the first slide rail 32, such that the first connecting rod 35 is able to rotate on a plane passing through the first slide rail 32.

The area of the connecting block 34 provided with the first ear plate 342 is less in thickness than the area of the connecting block 34 formed with the insertion port 341. In order to reduce the interference of the connecting block 34 on the rotation of first connecting rod 35, the connecting block 34 is provided with a slope 343 at a position between the insertion port 341 and the first ear plate 342.

Referring to FIG. 11 and FIG. 12, the driving gear assembly includes a mounting seat 36 and a toothed plate 37. The mounting seat 36 includes a shaft sleeve with a third shaft hole 364. A circumferential outer wall of the shaft sleeve is fixedly provided with a connecting part 361 configured to fixedly connect to the toothed plate 37. The toothed plate 37 is detachably fixed to the connecting part 361. A central axis of an outer rim of the teeth on the toothed plate 37 coincides with a center of the shaft sleeve.

The mounting seat 36 is rotatably connected to the first shaft hole 25 of the mounting bracket 2 through the third shaft hole 364 and a rotating shaft 38 that are cooperated. The mounting seat 36 is able to rotate around the rotating shaft 38. The rotating shaft 38 can be connected to the mounting bracket 2 through a bearing. The toothed plate 37 fixed on the mounting seat 36 is located at the mounting groove 27 and is able to perform a gear rotation action. When the teeth on the toothed plate 37 are worn or damaged and need to be replaced, the toothed plate 37 is detached from the connecting part 361 and a new toothed plate 37 is mounted. Thereafter, the driving gear assembly can still work, with the overall service life prolonged. The toothed plate 37 and the mounting seat 36 can also be connected through other detachable manners, such as clamping, inserting, joggling, embedding, etc.

The connecting part 361 is provided with at least one connecting hole. The toothed plate 37 can be fixedly connected to the connecting part 361 through a bolt inserted through the connecting hole. Herein, there are four connecting holes, which can be evenly disposed. In other embodiments, the number of the connecting holes may be 1, 2, 3, 5 or more, etc., depending on actual needs.

When the driving gear assembly does not need to perform a complete circular motion, but only to perform a partial circular motion, the toothed plate 37 can be a curved plate. Correspondingly, the connecting part 361 can be a curved plate too.

On an outer wall of the shaft sleeve is fixed a second ear plate 362. The second ear plate 362 is configured to hinge with the first connecting rod 35, whereby the first hydraulic cylinder 31 drives the slide rest to move to apply a torque to the driving gear assembly.

When the first connecting rod 35 is located at a middle position of the mounting seat 36, in order to prevent the first connecting rod 35 interfering with the mounting seat 36 to impact rotation, the shaft sleeve is formed with an opening 313 along the circumferential curved surface in the middle thereof, and the second ear plate 362 is arranged at an outer wall of the shaft sleeve corresponding to the opening. The second ear plate 362 can be arranged on one end of the opening 313, enabling the mounting seat 36 to rotate a greater angle. In other embodiments, the second ear plate 362 can also be arranged at a middle position of the corresponding opening 313 of the shaft sleeve.

In order to minimize the center of gravity shift of the entire driving gear assembly as much as possible after the toothed plate 37 is mounted, two second ear plates 362 are provided here that are distributed on two sides of the opening 313. The connecting part 361 is located at a curved surface area of the shaft sleeve opposite to the opening 313. An end surface of one side of the connecting part 361 is arranged close to a middle section of the opening 313, while an end surface of the other side is arranged far away the opening 313.

To ease the mounting and detaching between the rotating shaft 38 and the mounting seat 36, the mounting seat 36 is formed with a fixing hole 315 running through a side wall thereof radially. In this manner, when the mounting seat 36 is sleeved on the rotating shaft 38, a bolt is inserted through the fixing hole 315 to tighten and fix them.

In order to enhance the contact tightness between a cap of the bolt and an outer wall of the mounting seat 36 and to reduce the possibility of loosening of the bolt, an area around the fixing hole 315 on an outer wall of the shaft sleeve of the mounting seat 36 is a plane.

In other implementations of the present embodiment of the present disclosure, the second ear plate 362 can also be only one that is located on one side of the mounting seat 36, where the mounting seat 36 can also be formed without the opening 313. During mounting, the first connecting rod 35 is hinged with the second ear plate 362 from a lateral end of the mounting seat 36.

In other implementations of the present embodiment of the present disclosure, the connecting part 361 can be two or more in quantity, where the multiple connecting parts 361 can be distributed along a circumferential direction of the mounting seat 36, and the toothed plate 37 connected to the multiple connecting parts 361 can be formed into an incomplete gear. Alternatively, there are at least two connecting parts 361 arranged along an axial line direction of the shaft sleeve. In this manner, while rotating, the mounting seat 36 is able to drive multiple parallel connecting parts 361 to rotate, and the driving gear assembly can be formed into a double tooth structure.

Depending on needs, the toothed plate 37 can be a curved or fan-shaped plate, also can be a circular plate. The tooth modulus on the toothed plate 37 can be regulated, thereby being able to suit for different requirements of transmission ratio.

When the first hydraulic cylinder 31 drives the slide rest to move along the first slide rail 32, since the first connecting rod 35 is eccentrically connected to the driving gear assembly, the slide rest drives the driving gear assembly to rotate through the first connecting rod 35. By means of the linear reciprocal movement of the slide rest on the first slide rail 32, the driving gear assembly performs reciprocal swing around its own axial line, whereby driving the hip joint mechanism engaged with the driving gear assembly to rotate to cause the leg-foot mechanism to swing forward and backward. Since the first hydraulic cylinder 31 drives the slide reset to move linearly, the torque effect generated by traditional motor driving does not occur, which is easy to control.

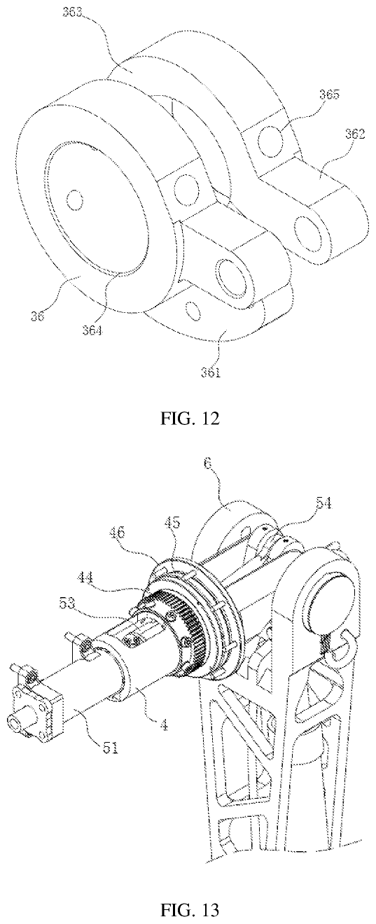

Referring to FIG. 13, the hip joint mechanism includes a connecting piece 4 and a lateral swing driving mechanism 5, and the lateral swing driving mechanism 5 is configured to drive the thigh arm 6 to perform inward and outward swing.

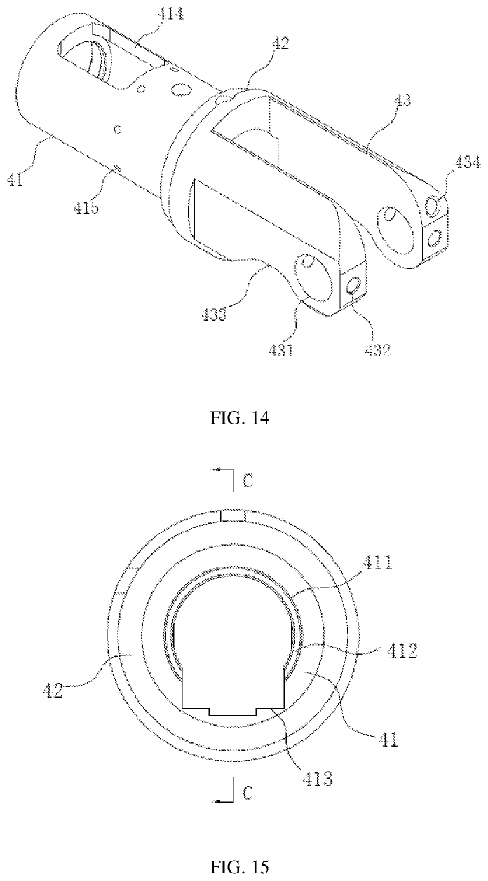

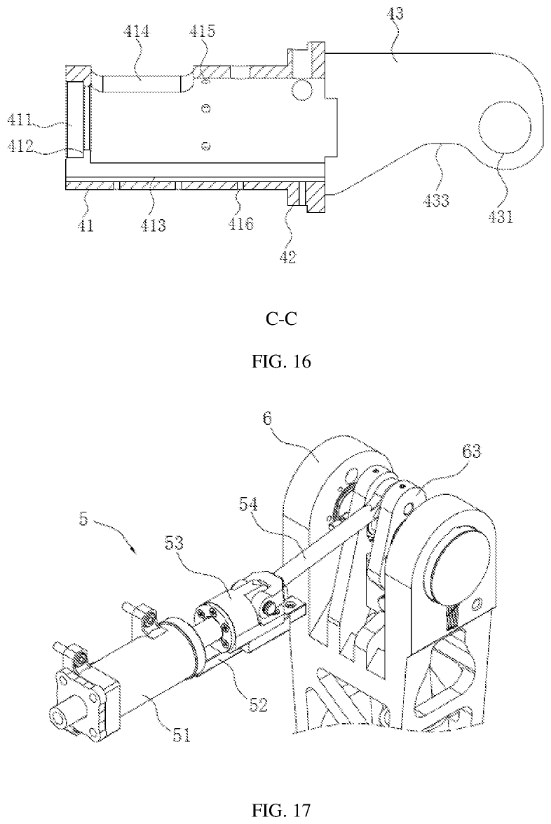

Referring to FIG. 14 and FIG. 16, the connecting piece 4 includes a mounting pipe 41 and a connecting ring 42 that are connected coaxially and fixedly. One end of the connecting ring 42 far away the mounting pipe 41 is fixed with a pair of support arms 43. The support arms 43 are configured to rotatably connect to the thigh arm 6.

Referring to FIG. 17, the lateral swing driving mechanism 5 includes a second hydraulic cylinder 51, a second slide rail 52, a slide rest 53 and a second connecting rod 54. The second hydraulic cylinder 51 is coaxially connected to one end of the mounting pipe 41 far away the connecting ring 42. The second slide rail 52 is fixed to an inner wall of the mounting pipe 41 along an axial direction of the mounting pipe 41. The slide rest 53 is connected to the second slide rail 52 and slides relative to the second slide rail 52. A piston rod of the second hydraulic cylinder 51 is connected to the slide rest 53. One end of the second connecting rod 54 is hinged with the slide rest 53 while the other end is hinged with the thigh arm 6.

The support arms 43 are rotatably connected to the thigh arm 6 to form preliminary support. The connecting piece 4 can be rotatably connected into the second shaft hole 26 of the mounting bracket 2 through a bearing 45. The extension and contraction of the piston rod of the second hydraulic cylinder 51 can drive the slide rest 53 located inside the mounting pipe 41 to slide on the second slide rail 52. The slide rest 53 drives the thigh arm 6 to swing around a rotating shaft through the second connecting rod 54. In this manner, when the robot is moving, the axial line of the second hydraulic cylinder 51 of the hip joint can remain relatively unchanged, the position reference is simplified, and it is convenient to optimize the robot control algorithm program.

The support arms 43 have one end far away the mounting pipe 41 formed with a fourth shaft hole 431, and an axial line of the fourth shaft hole 431 is perpendicular to an axial line of the mounting pipe 41. An end part of the thigh arm 6 is provided with an inner ear plate 63. The support arms 43 are rotatably connected to the thigh arm 6 through a rotating shaft inserted through the fourth shaft hole 431. The second connecting rod 54 is rotatably connected to the inner ear plate 63 through a pin shaft.

Referring to FIG. 14 to FIG. 16, a side wall of the mounting pipe 41 is formed with a perforation along a radial direction. A driven gear 44 is fixedly sleeved outside the mounting pipe 41. The driven gear 44 is fixed by a bolt inserted through the perforation 415 to prevent circumferential sliding. The drive gear 44 is engaged with an outer rim of the toothed plate 37. In this manner, when the hip joint mechanism is connected to the forward-and-backward swing driving assembly through the driving gear assembly, the hip joint mechanism can rotate around the axial line of the mounting pipe 41 entirely and synchronously. Due to gear transmission, the forward-and-backward swing accuracy of the leg-foot mechanism can be increased. There can be multiple perforations 415 that are evenly distributed along a circumferential direction of the mounting pipe 41, so that the connection points between the driven gear 44 and the mounting pipe 41 are stressed evenly, achieving reliable fixing.

Referring to FIG. 14 to FIG. 16, the inner wall of the mounting pipe 41 is formed with a mounting groove 413 along the axial direction. An area of the mounting pipe 41 at the mounting groove 413 is formed with a fixing hole 416. The second slide rail 52 can be fixed to the mounting pipe 41 through a bolt inserted through the fixing hole 416. A cross section of the mounting groove 413 can be a stepped shape, also can be other shapes, such as rectangle, trapezoid, semicircle, circle, etc.

In other implementations of the present embodiment of the present disclosure, the second slide rail 52 can also be embedded into or integrally formed with the mounting pipe 41.

The mounting pipe 41 is inside hollow to form a mounting hole 411. One end of the mounting pipe 41 far away the connecting ring 42 has a locating ring 412 fixed on an inner wall thereof. A cylinder end part of the second hydraulic cylinder 51 can abut against the locating ring 412 and is connected to the mounting pipe 41 through a bearing.

To facilitate operation or observation, the mounting pipe 41 is further formed with an operating hole 414 thereon. The operating hole 414 is formed close to the locating ring 412. The perforation 415 and the locating ring 412 are located on two ends of the operating hole 414 along the axial direction of the mounting pipe 41.

An outer wall of the connecting ring 42 can be of a stepped structure. The bearing 45 can be sleeved at the connecting ring 42, such that the leg-foot hip joint of the robot can be rotatably supported on the mounting bracket 2. In order to protect the bearing 45, the connecting ring 42 is further sleeved with an end cover 46. The end cover 46 can be fixed on the second shaft hole 26 of the mounting bracket 2 through a bolt. The connecting ring 42 has a greater external contour diameter than the mounting pipe 41. The connecting ring 42 enhances the structure strength at the connection between the support arms 3 and the mounting pipe 41.

Referring to FIG. 14 and FIG. 16, the fourth shaft hole 431 on the support arm 43 is disposed corresponding to the mounting hole 411 in height. The support arm 43 is formed with a pin hole 432 along a radial direction of the fourth shaft hole 431. The rotating shaft can be fixed by a bolt after passing through the fourth shaft hole 431, so that the rotating shaft remains stationary relative to the support arm 43, only with the thigh arm 6 rotating.

In order to reduce the occurrence that wires are entangled to cause failure when the robot's leg-foot mechanism is moving, the support arm 43 is formed with a wire channel 434 configured for cables to pass through. The wire channel 434 can be arranged along the axial direction of the mounting pipe 41. The wire channel 434 can be distributed on one of the support arms 43, also can be distributed on both of the support arms 43. Each support arm 43 can be formed with one wire channel 434, also can be formed with two or three wire channels, depending on needs.

Referring to FIG. 16 to FIG. 18, when the thigh arm 6 swings around the rotating shaft, in order to prevent a top end of the thigh arm 6 interfering with the support arms 43 to impact the swing range, the support arm 43 is formed with a receding groove 433 on an edge of one side close to the connecting ring 42.

The process of the leg-foot assembly performing the inward and outward lateral swing and the forward and backward swing is as follows. The first hydraulic cylinder 31 drives the slide block 33 to reciprocate on the first slide rail 32, the first connecting rod 35 connected to the connecting block 34 eccentrically pulls the mounting seat 36 to reciprocally swing, whereby the toothed plate 37 reciprocally swings, and the driven gear 44 engaged with the toothed plate 37 rotates reciprocally accordingly.

Since the connecting piece 4 is connected to the driven gear 4 coaxially and fixedly, the connecting piece 4 rotates reciprocally, and the thigh arm 6 rotatably connected to the connecting piece 4 swings forward and backward. Then, the hip joint mechanism rotates through the gear transmission under the power of the forward-and-backward swing driving assembly 2, thereby accurately controlling the thigh arm 6 to swing around the axial line of the mounting pipe 41.

The second hydraulic cylinder 51 operates to drive the slide rest 53 to slide reciprocally along the second slide rail 52, the second connecting rod 54 connected to the slide rest 53 pulls the inner ear plate 63 on the thigh arm 6 to swing reciprocally, whereby the thigh arm 6 implements inward and outward swing.

During the entire movement process of the robot's leg-foot mechanism, the axial line of the second hydraulic cylinder 51 of the lateral swing driving mechanism 5 and the axial line of the first hydraulic cylinder 31 of the forward-and-backward swing mechanism 3 remain unchanged, which is conducive to optimizing the robot control algorithm program.

The control algorithm simplification principle is illustrated as below. Take the transmission between two adjacent joints as an example. A three-dimensional rectangular coordinate system 1 (x1, y1, z1) is rotated θ1 around the axis z1, and a three-dimensional rectangular coordinate system 2 (x2, y2, z2) is rotated θ2 around the axis x2. Generally, when conversion is performed between two joints, taking the coordinate system 1 as a reference coordinate system, the spatial coordinate of the coordinate system 2 relative to the coordinate system 1 is as follows.

$$[ \begin{matrix}{x}_{2} cos {θ}_{1} & - {x}_{2} sin {θ}_{1} & 0 & {x}_{2} \\ {y}_{2} sin {θ}_{1} & {y}_{2} cos {θ}_{1} & 0 & {y}_{2} \\ 0 & 0 & 1 & {z}_{2} \\ 0 & 0 & 0 & 1\end{matrix} ] ,$$

when axial lines of the two joints intersect at a point, that is, the origins of the two joint coordinate systems coincide, the x2, y2 and z2 in the matrix are 0 that represent the distance to the origins of the two joint coordinate systems, which can simplify the matrix expression in transmission control software. The simplified spatial coordinate is expressed as:

$$[ \begin{matrix}cos {θ}_{1} & - s in {θ}_{1} & 0 & 0 \\ sin {θ}_{1} & cos {θ}_{1} & 0 & 0 \\ 0 & 0 & 1 & 0 \\ 0 & 0 & 0 & 1\end{matrix} ] .$$

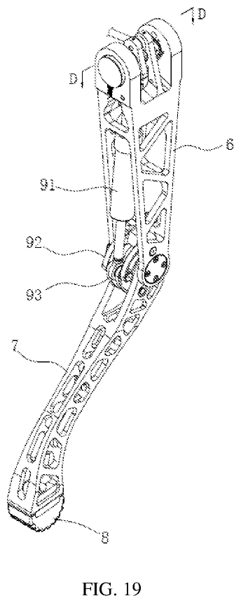

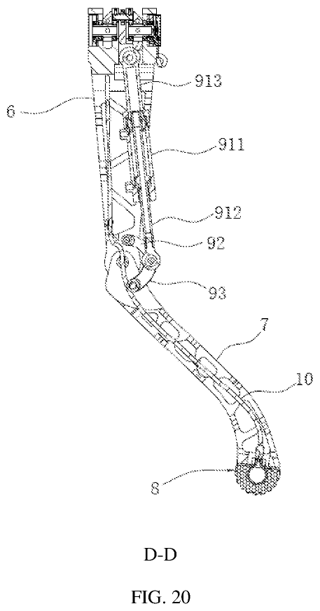

Referring to FIG. 19 and FIG. 20, the leg-foot mechanism includes a thigh arm 6, a shank arm 7 and a knee joint 9. The knee joint 9 includes a third hydraulic cylinder 91, a first connection part 92 and a second connection part 93. The thigh arm 6 is rotatably connected to the shank arm 7. A cylinder body 911 of the third hydraulic cylinder 91 is rotatably connected to the thigh arm 6. A piston rod 912 of the third hydraulic cylinder 91 is rotatably connected to the first connection part 92 and the second connection part 93. Another end of the first connection part 92 is rotatably connected to the thigh arm 6. Another end of the second connection part 93 is rotatably connected to the shank arm 7. A quadrilateral is formed between a rotation pivot point of the thigh arm 6 and the shank arm 7, a rotation pivot point of the first connection part 92 and the thigh arm 6, a rotation pivot point of the second connection part 93 and the shank arm 7, and a rotation pivot point of the first connection part 92 and the second connection part 93.

The knee joint 9 employs a four-link structure for transmission. In the condition that the shank arm 7 has the same angle of unfolding, the third hydraulic cylinder 91 in the four-link structure has the smallest swing amplitude.

The third hydraulic cylinder 91 can be a double acting cylinder, which employs a double-rod hydraulic cylinder herein. In order to protect the piston rod 912 of the third hydraulic cylinder 91, the cylinder 911 of the third hydraulic cylinder 91 is fixedly connected to a mounting frame 913. The mounting frame 913 can be a cylindrical rod hinged inside the thigh arm 6. One end of the cylindrical rod connected to the cylinder 911 is formed along an axial line with a cavity configured to accommodate the piston rod 912. The mounting frame 913 can be fixed to the cylinder 911 through a bolt.

The first connection part 92 and the second connection part 93 can both be a curved plate. A recess of the curved plate is disposed facing the rotation pivot point of the thigh arm 6 and the shank arm 7, which is more suitable for the transmission route of stress in structural components and prolongs the service life. In other implementations, the first connection part 92 and the second connection part 93 can also be a straight plate, an S-shaped plate, a V-shaped plate, etc.

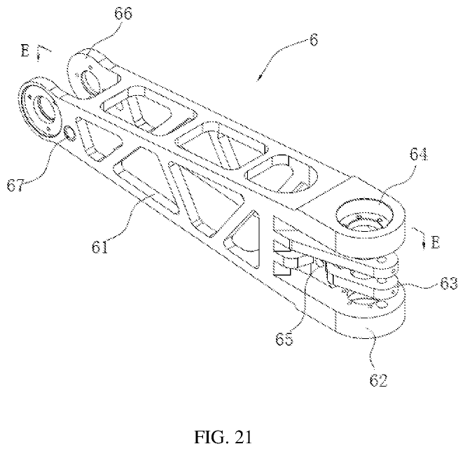

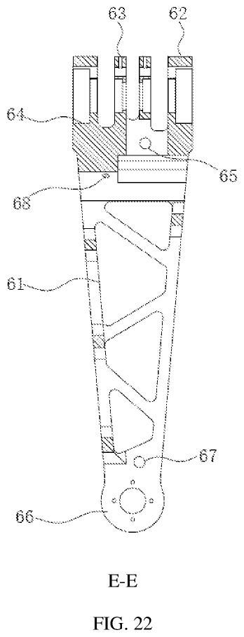

Referring to FIG. 21 and FIG. 22, the overall contour of the thigh arm 6 is a quadrangular prism structure. A cavity is formed inside the thigh arm 6. To further reduce weight, the thigh arm 6 has a surface formed with multiple first lightening holes 22 to form a hollow-out structure.

Two opposite side walls of one end of the thigh arm 6 are provided with a pair of outer ear plates 62. The outer ear plate 62 is formed with a shaft hole. Inner ear plates 63 are fixedly arranged between the two outer ear plates 62, and there can also be two inner ear plates 63. The two outer ear plate 62 are arranged parallel to the two inner ear plates 63. A mounting groove 64 is formed on an outer side of the outer ear plate 62 corresponding to the shaft hole, to mount an angle monitor.

The thigh arm 6 is formed with a pin hole 65 at a position close to the inner ear plate 63. An axial line of the pin hole 65 is perpendicular to that of the shaft hole of the inner ear plate 63. An end part of the mounting frame 913 is hinged at the pin hole 65, such that the third hydraulic cylinder 91 can be entirely received into the cavity inside the thigh arm 6.

Two opposite side walls of the other end of the thigh arm 6 are provided with a pair of first knee ear plates 66. The first knee ear plates 66 are formed with a shaft hole. The first knee ear plates 66 and the outer ear plates 62 are located on different side surfaces of the thigh arm 6 respectively. An axial line of the shaft hole on the first knee ear plate 66 is perpendicular to that of the shaft hole on the outer ear plate 62.

In order to further reduce the weight of the thigh arm 6, the thigh arm 6 tapers gradually in cross section from the end close to the outer ear plates 62 to the other end.

One end of the thigh arm 6 close to the outer ear plate 62 is further formed with a wire hole 68. The wire hole 68 is configured for a cable to pass through so that the wire is routed inside the thigh arm 6, reducing the occurrence of wire entangling while the leg-foot mechanism is moving and providing protection for the stable movement of the leg-foot system.

The thigh arm 6 is formed with a through hole 67 at a position close to the first knee ear plate 66. An axial line of the through hole 67 is parallel to that of the shaft hole of the first knee ear plate 66. The through hole 67 is configured for the first connection part 92 to hinge with the thigh arm 6.

The thigh arm 6 is rotatably connected to the support arm 43 of the connecting piece 4 through the shaft hole on the outer ear plate 62, such that the thigh arm 6 can swing inward and outward under an external power. The thigh arm 6 is rotatably connected to the shank arm 7 through the shaft hole on the first knee ear plate 66, such that a rotation is achieved between the thigh arm 6 and the shank arm 7 that is similar to the rotation at the human knee position. The thigh arm 6 is of a simple structure, optimizing the entire leg-foot structure.

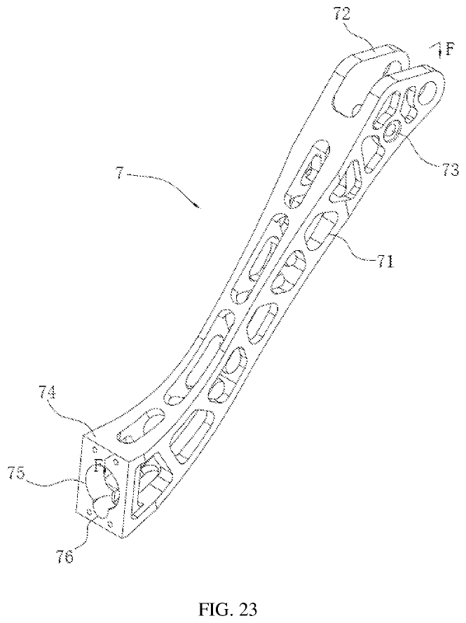

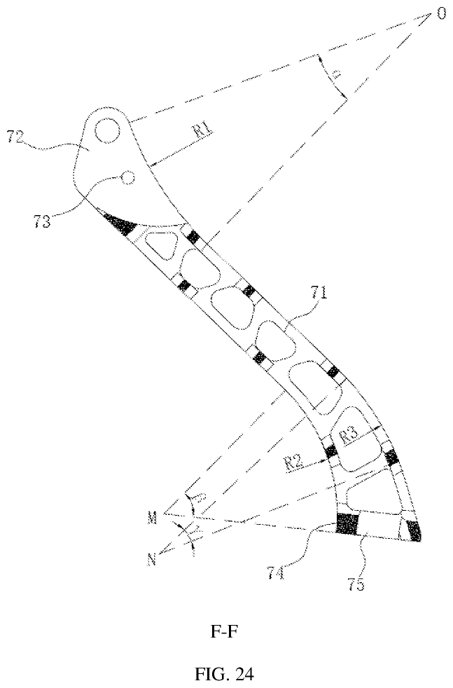

Referring to FIG. 23 and FIG. 24, the shank arm 7 is similar to a quadrangular prism structure entirely. The shank arm 7 is inside hollow. To further reduce the weight of the shank arm 7, the shank arm 7 has a surface formed with multiple second lightening holes 71 to form a hollow-out structure.

Two opposite side walls of one end of the shank arm 7 are provided with a pair of second knee ear plates 72. The second knee ear plates 72 are formed with a shaft hole. The shank arm 7 is rotatably connected to the thigh arm 6 by a shaft rod with the shaft holes of the first knee ear plates 71 aligned to the shaft holes of the second knee ear plates 72.

The shank arm 7 is formed with a perforation 73 at a position close to the shaft hole of the second knee ear plate 72. An axial line of the perforation 73 is parallel to that of the shaft hole of the second knee ear plate 72. The perforation 73 is configured for the second connection part 93 to hinge with the shank arm 7. The second knee ear plate 72 tapers gradually in width from the part of the perforation 73 to the part of the shaft hole.

The other end of the shank arm 7 is bended to form a curved section. One end of the shank arm 7 far away the second knee ear plate 72 is a foot connecting end 74. The foot connecting end 74 presents a square frustum structure. An end surface of the foot connecting end 74 is formed with a mounting hole 75 communicated with an inner cavity of the shank arm 7. The shank arm 7 is formed with nail holes around the mounting hole 75.

In order to better accord with human-body simulation science to enhance the support for leg-foot movement, the curved section of the shank arm 7 close to the foot connecting end 74 is bended toward one side. A bended inner side has a radius of R2, and the center angle of radian of the inner side is β. A bended outer side has a radius of R3, and the center angle of radian of the outer side is γ. Specifically, R2=54 mm, 0=52°, R3=80 mm, γ=20°. One surface of the shank arm 7 close to the shaft hole is partially bended, the bending radius is R1, the center angle of the curved surface is α, specifically, R1=100 mm, α=26°. Referring to FIG. 24, the center O of R1 and the center M of R2 are located at two sides of the shank arm 7, and curved surfaces corresponding to R1 and R2 are located on two opposite surfaces of the shank arm 7 respectively. In other implementations of the present embodiment of the present disclosure, R1, R2, R3, u, R and γ can all be selected appropriately as actually needed.

In order to reduce the weight of the shank arm 7 as much as possible, the shank arm 7 is formed with an extension groove 76 at an edge of the mounting hole 75.

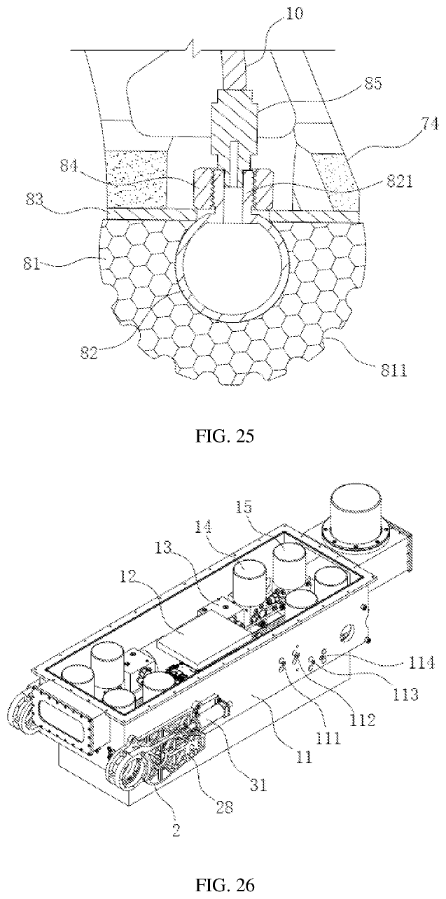

Referring to FIG. 25, the foot connecting end 74 is connected to a foot joint 8. The foot joint 8 includes a foot cover 81 and a cover plate 83. The foot cover 81 can be a rubber sleeve. The cover plate 83 is fixed to the foot connecting end 74 through a bolt. The foot cover 81 can be fixed onto the cover plate 83 by means of adhesion, welding or bolt. The foot cover 81 has a surface formed with multiple anti-slip grooves 811.

In order to conveniently detect the stress state of the foot joint 8, the foot joint 8 further includes an elastic inner capsule 82 that is filled with a fluid medium, such as hydraulic oil. The inner capsule 82 is wrapped by the foot cover 81. The inner capsule 82 is fixedly provided with a threaded section 821 that penetrates through the cover plate 83 and is then fixed by a nut 84. The inner capsule 82 is connected to a pressure sensor 85 at the threaded section 821. The pressure sensor 85 is connected to an external central processing unit such as a chip or a computer through a cable 10. When the foot cover 81 is stressed to deform and squeeze the inner capsule 82, the oil pressure inside the inner capsule 82 increases, the pressure sensor 85 detects the pressure value and then transmits it to the central processing unit through the cable 10.

During the walking process of the robot, the foot cover 81 generates certain degree of deformation after being squeezed by an external object, and then squeezes the elastic inner capsule 82 inwardly. Then, the pressure inside the inner capsule 82 changes, and the pressure sensor 85 is able to detect this pressure change in real time. Since all pressures from different directions of the foot cover 81 will finally be transferred to the inner capsule 82, the pressure sensor 85 is able to detect the stress condition in different directions.

Referring to FIG. 26, the control assembly 1 includes a chamber body 11 and a control unit 12. The leg-foot assembly is connected to the chamber body 11 through the mounting bracket 2. A first servo pump 13, a second servo pump 15 and a third servo pump 14 are mounted inside the chamber body 11. The control unit 12 is connected to the first servo pump 13, the second servo pump 15 and the third servo pump 14 respectively to perform control. The first servo pump 13 is connected to the first hydraulic cylinder 31. The second servo pump 15 is connected to the second hydraulic cylinder 51. The third servo pump 14 is connected to the third hydraulic cylinder 91. The first hydraulic cylinder 31 is configured to drive the leg-foot mechanism to swing forward and backward. The second hydraulic cylinder 51 is configured to drive the leg-foot mechanism to swing laterally inward and outward. The third hydraulic cylinder 91 is configured to drive the knee joint part to bend.

The chamber body 1 can be a rectangular shell structure. There are four sets of leg-foot assemblies that are mounted at four corners of the chamber body 1 respectively to form a four-legged robot. Each set of leg-foot assembly corresponds to one set of first servo pump 13, second servo pump 15 and third servo pump 14. The control unit 12 can be a central processing unit or a chip. The control unit 12 is connected to four sets of hydraulic pumps respectively to perform control.

The first servo pump 13, the third servo pump 14 and the second servo pump 15 can be arranged sequentially along a length direction of the chamber body 1. A side wall of the chamber body 1 along the length direction is formed with nail holes. The first servo pump 13 and the second servo pump 15 are mounted on the side wall of the chamber body 1 along the length direction through bolts respectively. A side wall of the chamber body 1 along a width direction is also formed with nail holes. The third servo pump 14 is mounted on the side wall of the chamber body 1 along the width direction through bolts.

Traditional hydraulic pumps and hydraulic cylinders are connected through flexible oil pipes, where the flexible oil pipes might be entangled or hooked by external foreign objects while the robot is walking, thereby impacting the stable operation of the robot. In order to improve the operation stability of the robot, the present disclosure is optimized by cancelling or reducing the application of oil pipes.

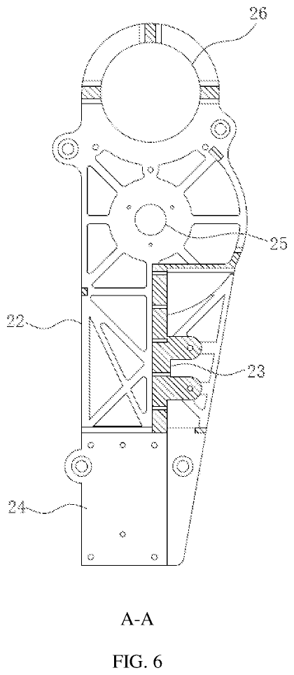

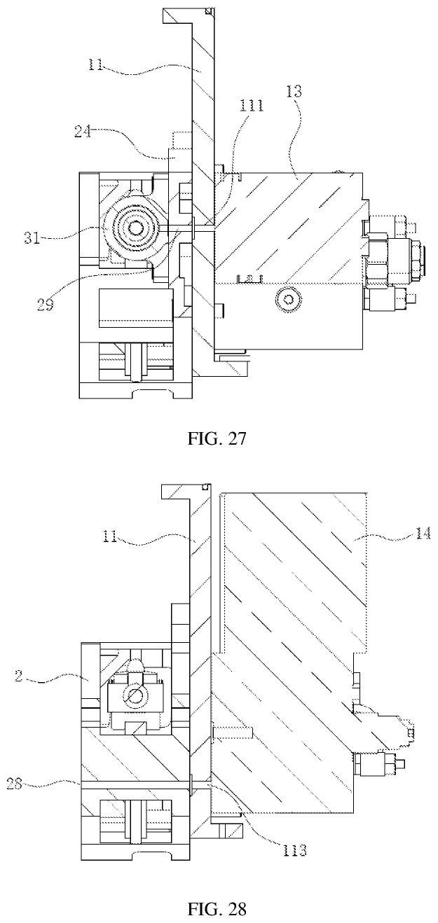

Referring to FIG. 6, FIG. 26 and FIG. 27, the mounting bracket 2 is fixed on a side wall of the chamber body 11 along the length direction through bolts. The first hydraulic cylinder 31 is fixed on the mounting bracket 2 through bolts. The second hydraulic cylinder 51 is fixed on a side wall of the chamber body 11 along the width direction through bolts.

A side wall of the chamber body 11 along the length direction is formed with a first oil outlet hole 111 and a first oil inlet hole 112. The first servo pump 13 is formed thereon with an oil inlet hole and an oil outlet hole. The first oil outlet hole 111 and the first oil inlet hole 112 correspond to the oil inlet and outlet holes of the first servo pump 13 in position and spacing, such that after the first servo pump 13 is mounted, the oil inlet hole on the first servo pump 13 is aligned to the first oil inlet hole 112 on the side wall of the chamber body 11, and the oil outlet hole on the first servo pump 13 is aligned to the first oil outlet hole 111 on the side wall of the chamber body 11. Contact positions between the first servo pump 13 and the first oil outlet hole 111 and the first oil inlet hole 112 are sealed by sealing rings.

An area of the mounting bracket 2 located at the fixing part 24 is formed with two first oil channels 29. A spacing between the two first oil channels 29 is the same as that between the first oil outlet hole 111 and the first oil inlet hole 112, such that after the mounting bracket 2 is fixed on the side wall of the chamber body 11, one first oil channel 29 is aligned to the first oil outlet hole 111 and the other first oil channel 29 is aligned to the first oil inlet hole 112. Contact positions between the mounting bracket 2 and the first oil outlet hole 111 and the first oil inlet hole 112 are sealed by sealing rings. In order to accommodate the sealing rings, the chamber body 11 is formed with sealing grooves around the first oil outlet hole 111 and the first oil inlet hole 112, and the sealing rings are placed into the sealing grooves.

The cylinder body of the first hydraulic cylinder 31 is also formed with oil inlet and outlet holes. The oil inlet hole of the first hydraulic cylinder 31 is communicated with the first oil channel 29 and the first oil inlet hole 112. The oil outlet hole of the first hydraulic cylinder 31 is communicated with the first oil channel 29 and the first oil outlet hole 111.

It is understandable that due to the reasons of specification and design of the first hydraulic cylinder 31 and the first servo pump 13, the spacing between the oil inlet and outlet holes on the first hydraulic cylinder 31 might be different from that on the first servo pump 13, where the first oil outlet hole 111 and the first oil inlet hole 112 on the chamber body 11 can select to be machined based on one of the spacings, for example, herein it selects to be machined based on the spacing between the oil inlet and outlet holes on the first servo pump 13. If the spacing between the oil inlet and outlet holes on the first hydraulic cylinder 31 is greater, the axial line of the first oil outlet hole 111 and/or the first oil inlet hole 112 is disposed obliquely with an acute angle from the normal line of the side wall of the chamber body 11. If the spacing between the oil inlet and outlet holes on the first hydraulic cylinder 31 is the same as that on the first servo pump 13, the axial line of the first oil outlet hole 111 and the first oil inlet hole 112 is disposed perpendicular to the side wall of the chamber body 11.

Likewise, the side wall of the chamber body 11 along the width direction is also formed with oil inlet and outlet holes that are configured to intercommunicate the second servo pump 15 with the second hydraulic cylinder 51.

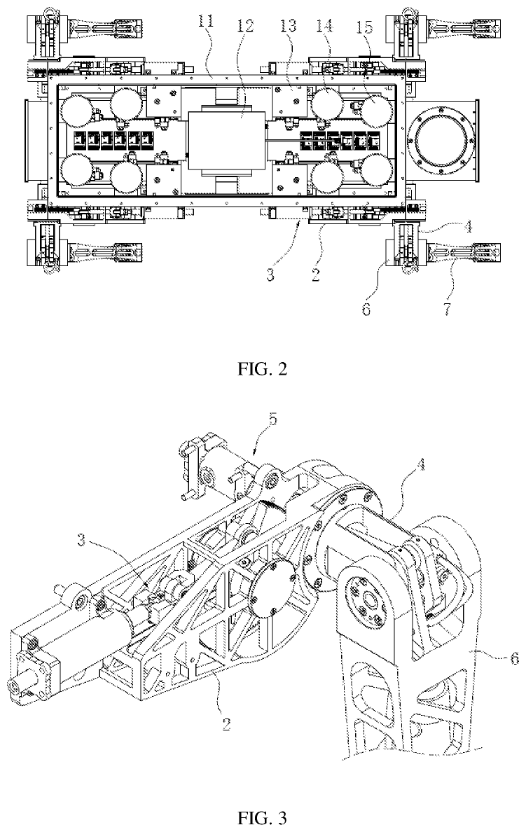

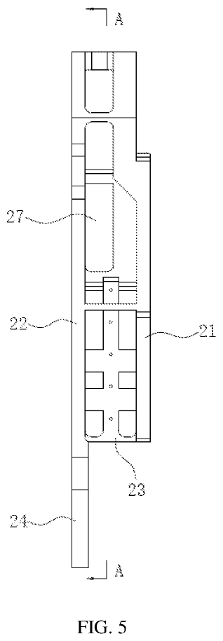

Referring to FIG. 2, FIG. 5 and FIG. 7, the side wall of the chamber body 11 is further formed with a second oil outlet hole 113 and a second oil inlet hole 114. The second oil outlet hole 113 and the second oil inlet hole 114 are configured to connect to oil inlet and outlet holes on the third servo pump 14 correspondingly.

Since the third hydraulic cylinder 91 is located on the thigh arm 6, in order to reduce the length of the flexible oil pipe, the mounting bracket 2 is further formed with two second oil channels 28. The second oil channel 28 runs through the first side plate 21 and the second side plate 22 of the mounting bracket 2. A spacing between the two second oil channels 28 is the same as that between the second oil outlet hole 113 and the second oil inlet hole 114. Contact positions between the mounting bracket 2 and the second oil outlet hole 113 and the second oil inlet hole 114 are sealed by sealing rings. The chamber body 11 is formed with sealing grooves around the second oil outlet hole 113 and the second oil inlet hole 114, and sealing rings are placed into the sealing grooves.

One ends of the second oil outlet hole 113 and the second oil inlet hole 114 far away the chamber body 11 are connected to the oil inlet and outlet holes of the third hydraulic cylinder 91 through oil pipes correspondingly. The oil pipes can be laid inside the mounting bracket 2, on one hand reducing the length of the oil pipes, and on the other hand reducing the likelihood of the oil pipes being hooked by external foreign objects or entangled.

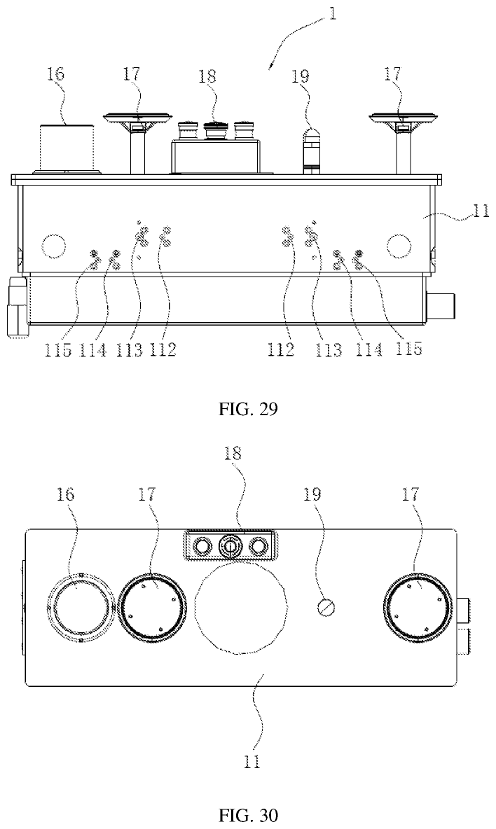

Referring to FIG. 29 and FIG. 30, in order to improve the explosion-proof performance of the robot, the internal pressure inside the chamber body 11 is designed as positive pressure. An upper cover of the chamber body 11 can be formed with an air nozzle for charging a protective gas into the chamber body 11. Since the control unit 12 and the servo motor for the first servo pump 13, the second servo pump 15 and the third servo pump 14 are located inside the chamber body 11, while the first cylinder 3, the second cylinder 4 and the third cylinder 5 are located outside the chamber body 11, the electrical parts of the robot are isolated and protected by the chamber body 11, achieving an electro-hydraulic separation effect and improving the explosion-proof performance of the robot.

According to the function running requirements of the robot, the upper cover of the chamber body 11 is further mounted with at least one of a laser radar 16, an RTK antenna 17, an explosion-proof button 18 and an explosion-proof audible and visual alarm 19. Herein, the laser radar 16 is sealed by a sealing glass cover, enhancing the explosion-proof performance. The RTK antenna 17, the explosion-proof button 18 and the explosion-proof audible and visual alarm 19 employ explosion-proof circuits. Glue is applied where the circuits pass through the chamber body 11 for sealing, enhancing the explosion-proof performance.

Due to the oil inlet and outlet holes designed on the side wall of the chamber body 11, each hydraulic pump can be directly connected to the oil inlet and outlet holes on the chamber body 11, the first hydraulic cylinder 31 and the second hydraulic cylinder 51 can be connected to the oil inlet and outlet holes designed on the side wall of the chamber body 11 respectively, which reduces the usage of oil pipes and improves the operation stability of the robot.

In order to simplify the composition of the hydraulic system and reduce the volume, thereby being able to reduce the volumes of the chamber body 11 and the robot and facilitating the load bearing and application of the robot, the present disclosure employs an EHA closed hydraulic system.

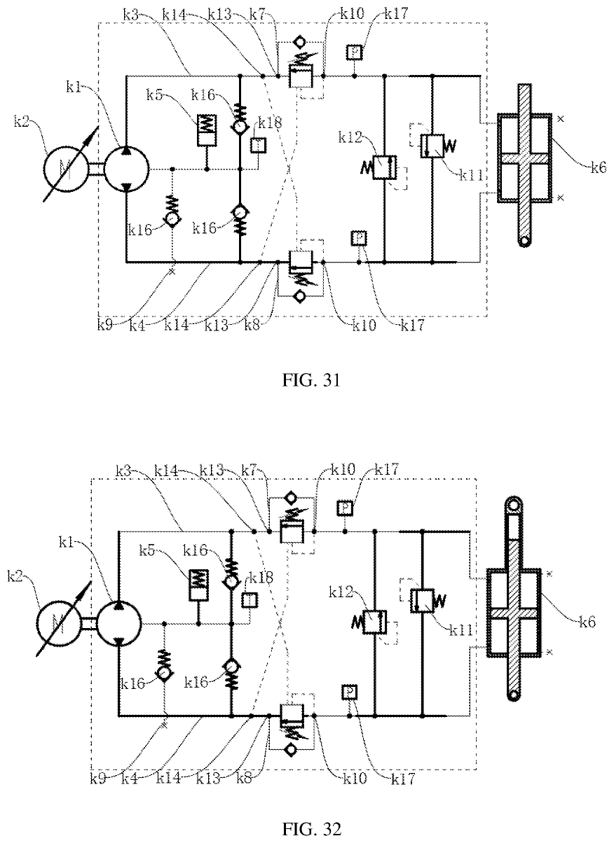

Referring to FIG. 31 and FIG. 32, the EHA closed hydraulic system includes a two-way pump k1, a motor k2 configured to drive the two-way pump k1 to rotate, a first main oil circuit k3, a second main oil circuit k4, an energy accumulator k5 and a symmetric actuating unit k6. Two suction ports of the two-way pump k1 are communicated with the first main oil circuit k3 and the second main oil circuit k4 respectively. The two-way pump k1 is communicated with the energy accumulator k5.

The EHA closed hydraulic system further includes a first one-way balance valve k7, a second one-way balance valve k8, and an oil filling port k9 unidirectionally communicated with the two-way pump k1 and the energy accumulator k5. First valve ports k10 of the first one-way balance valve k7 and the second one-way balance valve k8 are communicated with a first oil port and a second oil port of the symmetric actuating unit k6 respectively. Second valve ports k13 of the first one-way balance valve k7 and the second one-way balance valve k8 are communicated with oil inlet ports of the first main oil circuit k3 and the second main oil circuit k4 respectively.

A control valve port k14 of the first one-way balance valve k7 is communicated with the second main oil circuit k4 prior to the second valve port k13 of the second one-way balance valve k8. A control valve port k14 of the second one-way balance valve k8 is communicated with the first main oil circuit k3 prior to the second valve port k13 of the first one-way balance valve k7.

The first valve port k10 of the first one-way balance valve k7 is bidirectionally communicated with the first valve port k10 of the second one-way balance valve k8 through an overflow valve.

The energy accumulator k5 is communicated with the second valve ports k13 of the first one-way balance valve k7 and the second one-way balance valve k8 through one-way valves k16 respectively.

When the two-way pump k1 rotates clockwise, the oil liquid from the two-way pump k1 enters an upper chamber of the symmetric actuating unit k6 via the second valve port k13 and the first valve port k10 of the first one-way balance valve k7. If the symmetric actuating unit k6 is loaded, this circuit is of high-pressure oil by the time. On the oil return circuit of the lower chamber of the symmetric actuating unit k6, the oil liquid can return to the two-way pump k1 via the first valve port k10 and the second valve port k13 of the second balance valve only when the control valve port k14 of the second one-way balance valve k8 is turned on by means of the pressure control of the high-pressure hydraulic oil in the oil circuit prior to the second valve ports k13 of the first one-way balance valve k7. Once the pressure in the upper chamber of the symmetric actuating unit k6 decreases, the control valve port k14 of the second one-way balance valve k8 will not be turned on, and then the symmetric actuating unit k6 remains its position.

When the two-way pump k1 rotates anticlockwise, the oil liquid from the two-way pump k1 enters a lower chamber of the symmetric actuating unit k6 via the second valve port k13 and the first valve port k10 of the second one-way balance valve k8. If the symmetric actuating unit k6 is loaded, this circuit is of high-pressure oil by the time. On the oil return circuit of the lower chamber of the symmetric actuating unit k6, the oil liquid can return to the two-way pump k1 via the first valve port k10 and the second valve port k13 of the one-way balance valve only when the control valve port k14 of the first one-way balance valve k7 is turned on by means of the pressure control of the high-pressure hydraulic oil in the oil circuit prior to the second valve ports k13 of the first one-way balance valve k7. Once the pressure in the lower chamber decreases, the control valve port k14 of the first one-way balance valve k7 will not be turned on, and then the symmetric actuating unit k6 remains its position. Meanwhile, the second one-way balance valve k8 is in a unidirectional flow state or closed state, then the system motor k2 can stop rotating, and the symmetric actuating unit k6 can remain its position within any travel range. The two-way overflow valve connected between the first one-way balance valve k7 and the second one-way balance valve k8 achieves a protection function, which is configured to limit the system pressure within a certain value and prevent the system being over-pressured. When one side is over-pressured, the overflow valve on this side will be turned on for the oil liquid to flow to the low-pressure side.

The energy accumulator k5 on one hand is configured to store the oil liquid needed by the closed hydraulic circuit and the oil needing to be replenished due to the leakage of the hydraulic oil, and on the other hand is configured to maintain the oil suction pressure of the two-way pump k1 and replenish oil to the lower-pressure oil suction side. The oil filling port k9 is configured to fill oil to the system through the one-way valve k16. The energy accumulator k5 is configured to replenish oil to the lower-pressure side of the two-way pump k1 through the one-way valve k16.

In the present embodiment, the two-way pump k1 is a gear pump that includes a driving gear and a driven gear engaged with one another. The balance valve employs a plug-in design, with advantages of compact flow channel and small volume, which helps further reduce the volume of the pump-valve integrated device and enables a more compact entire structure. The energy accumulator k5 is a spring loaded accumulator, a piston accumulator or an oil resistant elastomer type accumulator. The oil resistant elastomer type accumulator can be an airbag or diaphragm type accumulator. The present embodiment employs the spring loaded accumulator, which stores and releases the hydraulic energy by means of the compression and stretching of the spring. The spring is isolated from the pressure oil by a piston, and the force of the spring is acted onto the hydraulic oil by means of the piston.

The present solution employs an electrostatic circuit based on a symmetrical hydraulic cylinder, rather than on an asymmetrical hydraulic cylinder whose upper chamber and lower chamber are of different capacities and different flow rates and thus would increase the complexity of the system. The present system does not need an oil replenishment circuit composed of a dual hydraulic control one-way valve and a large accumulator. Therefore, the circuit principle is greatly simplified. When the present system is applied to the leg joints of the four-legged robot, the balance valve on the circuit is to achieve two purposes. One purpose is to lock the robot joint at any angle within the joint angle range, regardless of whether the robot is powered off or not. This function means that in the case of power off, the robot can keep long-time standing in any stable posture. The other purpose is to suit for the squatting negative load condition corresponding to the fourth quadrant, such that the robot can implement squatting smoothly. In this manner, not only the working condition requirements are realized, but the system is simple, which greatly reduces the volume and weight needed by the hydraulic system and meanwhile enhances the reliability of the system. In addition, the standing in any stable posture is realized in the power off state.

In the present embodiment, specifically, the symmetric actuating unit k6 is a double piston rod hydraulic cylinder. The two-way pump k1 of the system employs a quantitative gear pump. When the system is in a working condition requiring variable flow rate, specifically, the variation of flow rate and the variation of oil liquid flow direction can be realized by changing the rotation rate and rotation direction of the motor k2. The motor k2 is controlled by a driver 44 through an encoder to achieve a closed loop control of rotation rate, whereby achieving accurate control of rotation rate and rotation direction. The overflow valve includes a first overflow valve k11 and a second overflow valve k12.

The EHA closed hydraulic system can further include pressure sensors k17 connected to the first valve ports k10 of the first one-way balance valve k7 and the second one-way balance valve k8 respectively. The two pressure sensors k17 are configured to measure the oil liquid pressures of the first main oil circuit k3 and the second main oil circuit k4 respectively, for the hydraulic system and the actuator mechanism to form dynamic control.

The EHA closed hydraulic system can further include temperature sensors k18 connected to the first main oil circuit and the second main oil circuit respectively. The temperature sensors k18 are configured to measure the temperature of the leaked oil and replenished oil of the system, and the oil temperature is used for the setting of system temperature alarm signals.

All the components and parts in this device are integrated into one valve block. Herein, the gear pump has no separate shell, with a rated speed of 3000 r/min, and a peak speed up to 4000 r/min. The double piston rod hydraulic cylinder has a maximum oil flow rate of 3 L/min, and the system has a maximum working pressure of 20 MPa. A transmission shaft of the motor is also designed and machined together with them. As a transmission shaft of the gear pump, it is connected to the driving gear of the gear pump through a shaft coupler.

Conventional hydraulic system design requires the use of a standard motor, a coupler, a bell cover and a gear pump, with the volume greatly increased. The pump-valve integrated device in this solution solves the problem that a closed system has a too large volume and shape, compared to conventional hydraulic systems. When applied to a walking robot, the device avoids the fact that the hydraulic system is too large to cause a too large volume of the entire product and thus result in difficulties in load bearing and application.

The present disclosure provides a joint electro-hydraulic combination transmission solution according to the joint application working condition of the four-legged robot. The leg joints of the robot are mainly divided into a hip lateral swing joint, a hip rotating joint and a knee joint. The ground environment can be divided into a flat ground, a slope and stairs. No matter in which environment, the legged robot has a working condition of four legs touching the ground to adjust the posture. For the trunk of the robot, the centroid posture is adjusted in the directions of six spatial degrees of freedom. However, since the three different joints for hip lateral swing, hip rotation and knee rotation are located at different joint positions, when the four legs touch the ground to adjust the posture, their respective load conditions are different. Since the second hydraulic cylinder 51 and the first hydraulic cylinder 31 are both located on the trunk, their corresponding working conditions are similar. However, the third hydraulic cylinder 91 of the knee joint 9 is mounted on the leg, its working condition is different from those of the other two hydraulic cylinders.

The working condition of the hydraulic cylinder 91 of the knee joint 9 is as follows.

When the four-legged robot's foot ends all touch the ground, the knee joint 9 has two working conditions. One is that the piston rod of the hydraulic cylinder is contracted under the action of the robot trunk and load, the angle of the corresponding knee joint 9 becomes smaller, which is a negative load condition. The other one is that the piston rod of the hydraulic cylinder is extended out after overcoming the weight of the robot trunk and load, the angle of the corresponding knee joint 9 becomes bigger, which is a positive load condition.

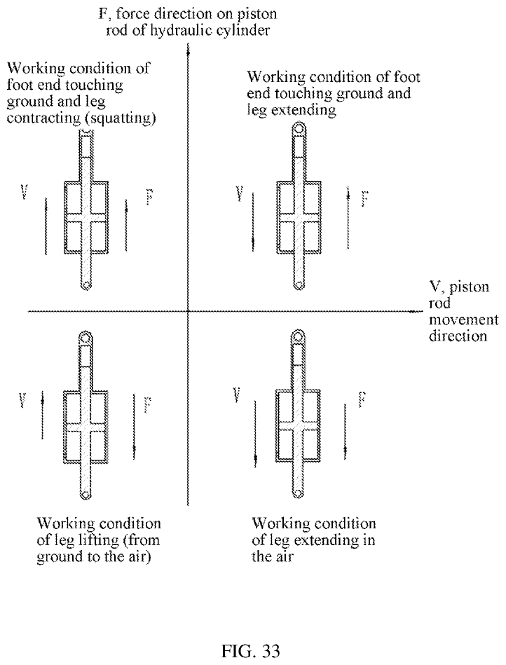

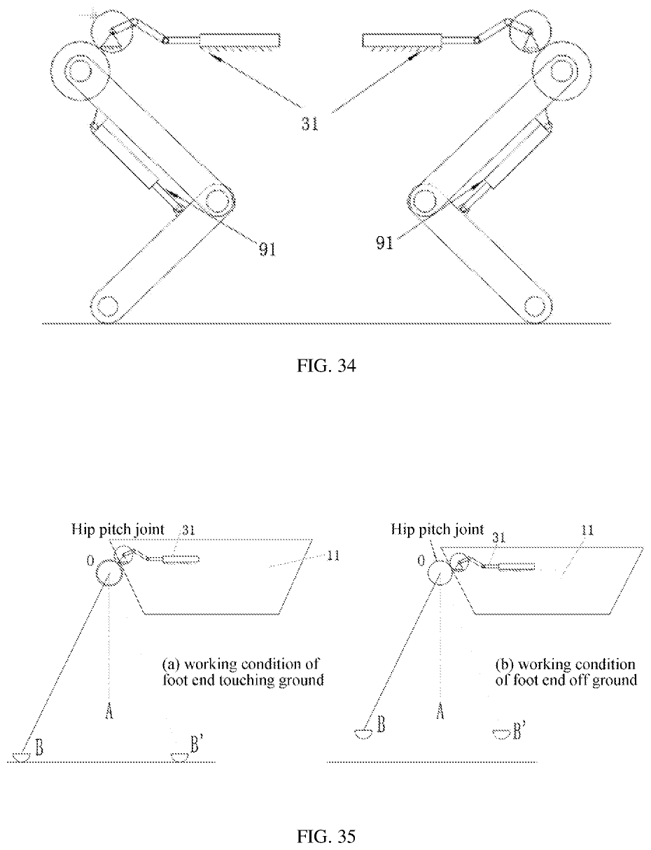

When one leg end of the four-legged robot is off the ground and executes certain trajectory in the air, during the leg lifting process, the knee rotation joint needs to overcome the weight of the leg and contracts the piston rod of the hydraulic cylinder, and the angle of the corresponding joint becomes smaller, which is the positive load condition. During the leg landing process, since the leg generally employs a lightweight design, the leg weight is small by the time. In order to accelerate the landing speed of the leg end, if the hydraulic cylinder of the knee joint 9 is extended, the hydraulic pump should work in the pumping state by the time, at which the hydraulic cylinder might be in the load condition, also to consider the extreme condition where an external force pulls the knee joint 9. Through the above analysis, in the four-legged robot, the load condition of the knee joint 9 is as shown in FIG. 33 and FIG. 34.

FIG. 33 shows the joint layout diagram of the four-legged robot. The knee joint 9 employs a hydraulic cylinder+link rotation driving mode. In a planar coordinate system formed by a load force F and a hydraulic cylinder piston rod velocity v, the load conditions of the third hydraulic cylinder 91 of the knee joint 9 are concentrated in the first, second, third and fourth quadrants, and corresponding functions are completed in each quadrant. Directions of the load force and the hydraulic cylinder piston rod velocity are as shown in the FV diagram in FIG. 33.

The EHA closed hydraulic system of the present disclosure employs a closed hydraulic system based on a symmetric actuating unit, which requires no oil replenishment circuit composed of a dual hydraulic control one-way valve and a large energy accumulator compared to an asymmetric hydraulic cylinder. Therefore, the circuit principle can be greatly simplified. In addition, the first one-way balance valve k7 and the second one-way balance valve k8 are mounted on the circuit, which are to achieve to purposes. One purpose is to lock the robot joint at any angle within the joint angle range, regardless of whether the robot is powered off or not. This function means that in the case of power off, the robot can keep long-time standing in any stable posture. The other purpose is to suit for the squatting load condition corresponding to the fourth quadrant, such that the robot can implement squatting smoothly. In this manner, not only the working condition requirements are realized, but the system is simple, which greatly reduces the volume and weight needed by the hydraulic system and meanwhile enhances the reliability of the system. In addition, the standing in any stable posture is realized in the power off state.

The lateral swing and pitch working conditions of the hydraulic cylinder of the hip joint mechanism are as follows.

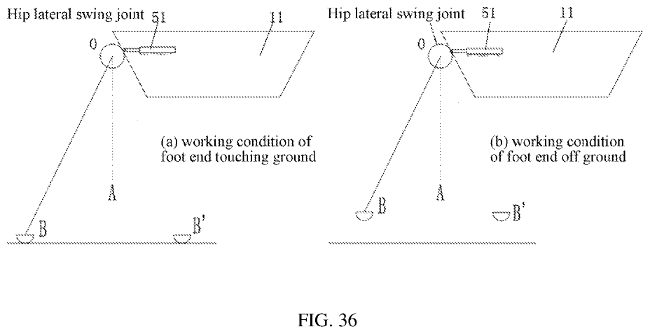

FIG. 35(a) is the working condition of the foot end of the hip pitch joint touching a ground. FIG. 35(b) is the working condition of the foot end of the hip pitch joint off a ground. FIG. 36(a) is the working condition of the foot end of the hip lateral swing joint touching a ground. FIG. 36(b) is the working condition of the foot end of the hip lateral swing joint off a ground.

For the hip lateral swing joint, the load condition changes with the angle of the hip lateral swing joint.

When the foot end touches the ground, the acting force on the foot end by the ground is upward. Depending on different positions of the leg relative to the chamber body 11, the torque directions generated for the hip lateral swing joint and the hip pitch joint are different. As shown by the working condition of the foot end of the hip pitch joint touching a ground in FIG. 35(a) and the working condition of the foot end of the hip lateral swing joint touching a ground in FIG. 36(a), when the leg is at the left position of the central line OA, as shown by OB, the torque acting on the hip lateral swing joint and the hip pitch joint by the ground is in a clockwise direction. However, when the leg is at the right position of the central line OA, as shown by OB′, the torque acting on the hip lateral swing joint and the hip pitch joint by the ground is in an anticlockwise direction. Therefore, when the hip lateral swing joint and the hip pitch joint swing in both directions at the OB or OB′ position, the four quadrants of load conditions will appear, and both positive load and negative load will appear.

When the foot end is off the ground, the gravity of the whole leg is always downward, as shown by the working condition of the foot end of the hip pitch joint off a ground in FIG. 35(b) and the working condition of the foot end of the hip lateral swing joint off a ground in FIG. 36(b). When the leg is at the left position of the central line OA, as shown by OB, the torque generated by the leg gravity is in the anticlockwise direction of the hip lateral swing center. When the leg is at the left position of the central line OA, as shown by OB′, the torque generated by the leg gravity is in the clockwise direction of the hip lateral swing center. Since the whole leg employs a lightweight design, if the torque generated by the friction force of the hip lateral swing joint actuator is greater than the torque generated by the gravity, there exists only two positive load conditions.

When the EHA closed hydraulic system of the present disclosure is applied to a four-legged robot, the hydraulic principles of the hip pitch joint, the hip lateral swing joint and the knee rotation joint of the four-legged robot are unified, with the extreme condition where an external force pulls the knee joint and the condition of bidirectional negative load of all joints taken into consideration, whereby providing convenience for the subsequent common use and maintenance of the parts and components.

The first one-way balance valve k7 and the second one-way balance valve k8 on the hydraulic circuit can avoid the condition of the two-way pump k1 becoming a motor and the motor becoming an electric generator in a negative load condition, thereby avoiding causing difficulty to the subsequent electric energy control. For example, in the following working conditions, when the resultant force direction and the movement direction of the hydraulic are the same, both downward, the working condition becomes a negative load condition, the pressure of the upper chamber of the hydraulic cylinder will decrease, the control circuit pressure of the second one-way balance valve k8 is insufficient to turn on the second one-way balance valve k8, then the oil liquid in the lower chamber is sealed inside the oil chamber and pipeline of the hydraulic cylinder and does not return to the two-way pump k1, ensuring the hydraulic cylinder to remain its position in the negative load condition and avoiding the abnormal operation of the two-way pump k1.

The above are the preferred embodiments of the present disclosure and are not intended to limit the scope of protection of the present disclosure. Any equivalent variations made according to the structure, shape and principle of the present disclosure are all intended to be covered in in the scope of protection of the present disclosure.

What is claimed is:

1. An electro-hydraulic combination driven explosion-proof legged robot, comprising a positive-pressure chamber body (11) and a leg-foot assembly, the leg-foot assembly comprising a hydraulic cylinder, wherein a servo pump is arranged inside the chamber body (11), the hydraulic cylinder is located outside the chamber body (11), and the chamber body (11) has a chamber wall formed with oil inlet and outlet holes configured to intercommunicate the servo pump with the hydraulic cylinder;
the leg-foot assembly comprising a mounting bracket (2), a leg-foot forward-and-backward swing mechanism (3), a hip joint mechanism and a leg-foot mechanism, wherein the leg-foot forward-and-backward swing mechanism (3) and the hip joint mechanism are connected outside the chamber body (11) through the mounting bracket (2), the hip joint mechanism is connected to the leg-foot mechanism and is able to drive the leg-foot mechanism to swing laterally inward and outward, the leg-foot forward-and-backward swing mechanism (3) is connected to the hip joint mechanism in a transmission manner and is able to drive the hip joint mechanism to rotate.

2. The electro-hydraulic combination driven explosion-proof legged robot according to claim 1, wherein the leg-foot forward-and-backward swing mechanism (3) is connected to the hip joint mechanism in a coaxial transmission manner.

3. The electro-hydraulic combination driven explosion-proof legged robot according to claim 2, wherein the hip joint mechanism comprises a connecting piece (4) and a lateral swing driving mechanism (5), the connecting piece (4) is rotatably connected to the mounting bracket (2), the lateral swing driving mechanism (5) is connected between the connecting piece (4) and the leg-foot mechanism, and the lateral swing driving mechanism (5) is configured to provide a power for the inward and outward lateral swing of the leg-foot mechanism.

4. The electro-hydraulic combination driven explosion-proof legged robot according to claim 3, wherein on the connecting piece (4) is coaxially sleeved and fixed a driven gear (44), the leg-foot forward-and-backward swing mechanism (3) comprises a driving gear assembly and a power assembly, the driving gear assembly is rotatably connected to the mounting bracket (2) and is engaged with the driven gear (44), and the power assembly is configured to drive the driving gear assembly to rotate.

5. The electro-hydraulic combination driven explosion-proof legged robot according to claim 4, wherein the power assembly comprises a first hydraulic cylinder (31), a first slide rail (32), a slide rest (53) and a first connecting rod (35); the first slide rail (32) is fixedly mounted to the mounting bracket (2), and a length direction of the first slide rail (32) is perpendicular to a rotation axial line of the connecting piece (4); a cylinder body (911) of the first hydraulic cylinder (31) is fixed to the mounting bracket (2); a piston rod (311) of the first hydraulic cylinder (31) is connected to the slide rest (53) and is able to drive the slide rest (53) to slide relatively along the first slide rail (32); and one end of the first connecting rod (35) is hinged with the slide rest (53) while the other end is eccentrically and rotatably connected to the driving gear assembly.

6. The electro-hydraulic combination driven explosion-proof legged robot according to claim 3, wherein the connecting piece (4) comprises a mounting pipe (41) and a pair of support arms (43), the support arms (43) are arranged along an axial line of the mounting pipe (41) and fixed on one end of the mounting pipe (41), the mounting pipe (41) is rotatably connected to the mounting bracket (2), the support arms (43) have one end far away the mounting pipe (41) formed with a shaft hole, and an axial line of the shaft hole is perpendicular to the axial line of the mounting pipe (41).

7. The electro-hydraulic combination driven explosion-proof legged robot according to claim 6, wherein the lateral swing driving mechanism (5) comprises a second hydraulic cylinder (51), a second slide rail (52), a slide rest (53) and a second connecting rod (54); the second slide rail (52) is fixed to an inner wall of the mounting pipe (41) along an axial line; the second hydraulic cylinder (51) is connected to one end of the mounting pipe (41) far away the support arms (43); the second hydraulic cylinder (51) is able to drive the slide rest (53) to slide relatively along the second slide rail (52); and one end of the second connecting rod (54) is hinged with the slide rest (53) while the other end extends out of the mounting pipe (41) toward the support arms (43).

8. The electro-hydraulic combination driven explosion-proof legged robot according to claim 1, wherein a first servo pump (13) is connected inside the chamber body (11), the leg-foot forward-and-backward swing mechanism (3) comprises a first hydraulic cylinder (31), the chamber body (11) has a side wall formed with penetrating first oil outlet hole (111) and first oil inlet hole (112), and the first oil outlet hole (111) and first oil inlet hole (112) are configured to intercommunicate the first servo pump (13) with the first hydraulic cylinder (31).

9. The electro-hydraulic combination driven explosion-proof legged robot according to claim 8, wherein a second servo pump (14) is connected inside the chamber body (11), the hip joint mechanism comprises a second hydraulic cylinder (51), and the chamber body (11) has a side wall formed with oil inlet and outlet holes configured to intercommunicate the second servo pump (14) with the second hydraulic cylinder (51).

10. The electro-hydraulic combination driven explosion-proof legged robot according to claim 8, wherein the first hydraulic cylinder (31) is fixed to the mounting bracket (2), and the mounting bracket (2) is provided with first oil channels (29) configured to connect to the first oil outlet hole (111) and first oil inlet hole (112) respectively.

11. The electro-hydraulic combination driven explosion-proof legged robot according to claim 9, wherein a third servo pump (15) is connected inside the chamber body (11), the leg-foot mechanism comprises a third hydraulic cylinder (91), and the chamber body (11) has a side wall formed with a second oil outlet hole (113) and a second oil inlet hole (114) configured to communicate with the third servo pump (15).

12. The electro-hydraulic combination driven explosion-proof legged robot according to claim 11, wherein the mounting bracket (2) is further formed with second oil channels (28) configured to connect to the second oil outlet hole (113) and the second oil inlet hole (114) respectively, and the second oil channels (28) are communicated with the third hydraulic cylinder (91).

13. The electro-hydraulic combination driven explosion-proof legged robot according to claim 9, wherein two ends of the oil inlet and outlet holes of the chamber body (11) are provided with sealing rings.

14. The electro-hydraulic combination driven explosion-proof legged robot according to claim 13, wherein the chamber body (11) is formed with a sealing groove configured to place the sealing ring.

15. The electro-hydraulic combination driven explosion-proof legged robot according to claim 1, wherein the leg-foot mechanism comprises a thigh arm (6), a shank arm (7) and a knee joint (9); the thigh arm (6) is rotatably connected to the shank arm (7); the knee joint (9) comprises the third hydraulic cylinder (91), a first connection part (92) and a second connection part (93); a cylinder body (911) of the third hydraulic cylinder (91) is rotatably connected to the thigh arm (6); another end of the first connection part (92) is rotatably connected to the thigh arm (6); another end of the second connection part (93) is rotatably connected to the shank arm (7); and a quadrilateral is formed between a rotation pivot point of the thigh arm (6) and the shank arm (7), a rotation pivot point of the first connection part (92) and the thigh arm (6), a rotation pivot point of the second connection part (93) and the shank arm (7), and a rotation pivot point of the first connection part (92) and the second connection part (93).

16. The electro-hydraulic combination driven explosion-proof legged robot according to claim 1, wherein the leg-foot mechanism comprises a foot joint (8), the foot joint (8) comprises a foot cover (81) and an elastic inner capsule (82) arranged inside the foot cover (81), and the inner capsule (82) is connected to a pressure sensor (85).

17. The electro-hydraulic combination driven explosion-proof legged robot according to claim 1, wherein the chamber body (11) is provided with at least one of a laser radar (16), an RTK antenna (17), an explosion-proof button (18) and an explosion-proof audible and visual alarm (19).

18. The electro-hydraulic combination driven explosion-proof legged robot according to claim 17, wherein a sealing glass cover is arranged around the laser radar (16).

19. The electro-hydraulic combination driven explosion-proof legged robot according to claim 17, wherein circuits of the RTK antenna (17), the explosion-proof button (18) and the explosion-proof audible and visual alarm (19) are explosion-proof cables, and glue is applied where the explosion-proof cables pass through the chamber body (11) for sealing.
